(19) United States
(12) Patent Application Publication
(10) Pub. No.: US 2005/0001789 A1
(43) Pub. Date: Jan. 6, 2005

(54) Apparatus and method of realizing three-dimensional image for a plasma display panel

(76) Inventor: Jeong Pil Choi, Suwon-si (KR)

Correspondence Address: FLESHNER & KIM, LLP, P.O. BOX 221200, CHANTILLY, VA, 20153, US

(21) Appl. No.: 10/875,614

(22) Filed: Jun. 25, 2004

(30) Foreign Application Priority Data
Jun. 26, 2003 (KR) 10-2003-0042119

(51) Int. Cl. G09G 5/00

(52) U.S. Cl. 345/8

(57) ABSTRACT

The present invention relates to a plasma display panel, and more specifically, an apparatus and a method of realizing three-dimensional image for a plasma display panel. According to an embodiment of the present invention, an apparatus of realizing a three dimensional image for a plasma display panel, comprises: a goggle which an observer wears; a first subfield mapping part for receiving a left data, which includes an image displayed in a left side of said goggle, and assigning the left data on each left subfield; a second subfield mapping part for receiving a right data, which includes an image displayed in a right side of said goggle, and assigning the right data on each right subfield; a subfield composing part for arranging the left subfields and the right subfields transmitted by said first subfield mapping part and said second subfield mapping part in one frame; and a goggle signal generating part for generating a left goggle signal and a right goggle signal, and applying the left goggle signal and the right goggle signal to said goggle corresponding to the left subfields and the right subfields arranged by said subfield composing part.

This Nonprovisional application claims priority under 35 U.S.C. § 119(a) on Patent Application No. 10-2003-0042119 filed in Korea on Jun. 26, 2003, the entire contents of which are hereby incorporated by reference.

### BACKGROUND OF THE INVENTION

1. Field of the Invention

The present invention relates to a plasma display panel, and more specifically, an apparatus and a method of realizing three-dimensional image for a plasma display panel.

2. Description of the Background Art

Generally, a goggle is used for an observer to recognize a two dimensional image displayed on a monitor as a three dimensional image.

FIG. 1 is a schematic diagram depicting an apparatus for realizing a three dimensional image in accordance with the background art. As shown in FIG. 1, the apparatus in accordance with the background art comprises a monitor signal processing part 20 and a goggle signal processing part 22.

The monitor signal processing part 20 comprises a data processing part 2 for adjusting data(R, G, B), applied from the outside, to a resolution of a cathode ray tube, and a cathode ray tube 4 for displaying an image horizontal synchronizing signal H and vertical synchronizing signal V, applied from the outside. The cathode ray tube 4 includes various driving parts, for example a electron gun driving part, a power supply driving part, which are not shown, and displays an image by controlling these driving parts.

The goggle signal processing part 22 comprises a control part 6 for generating a control signal corresponding to the horizontal synchronizing signal H and vertical synchronizing signal V applied from the outside, a goggle signal generating part 8 for generating left/right goggle signal corresponding to the control signal of the control part 6, a transformer 10 for transforming the voltages of the left/right goggle signals, and a goggle 12 for receiving the left/right signals applied from the transformer 10.

The control part 6 divides the frequencies of the horizontal and vertical synchronizing signals, and generates the control signal by using the divided horizontal and vertical synchronizing signals. The goggle signal generating part 8 generates left/right goggle signals corresponding to the control signal of the control part 6, and applies the left/right goggle signals to the transformer 10. The transformer 10 transforms the voltages of the left/right goggle signals to the voltage used in the goggle 12 and applies the left/right goggle signals to the goggle 12. The goggle 12 represents two dimensional image displayed in the cathode ray tube 4 as three dimensional image with receiving the left/right goggle signals. FIG. 2 is signal graph depicting left/right goggle signals generated in the goggle signal generating part of FIG. 1. As shown in FIG. 2, the left/right goggle signals, which are synchronized with the vertical synchronizing signal V, are applied to the goggle 12.

Recently, a plasma display panel (hereinafter, referred to as “PDP”) is highlighted because the PDP is slim, light, and available to realize clear and big screen in contrast to the cathode ray tube 4.

FIG. 3 is a drawing depicting one frame of a plasma display panel. As shown in FIG. 3, if it is desired to display a picture using 256 gray scales, the frame period 16.67 ms corresponding to 1/60 second is divided into eight sub-fields SF1 to SF8. Furthermore, each of the eight sub-fields SF1 to SF8 is divided into a reset and address period and a sustain period. The reset and address period of each sub-field are same every sub-field, whereas the sustain period is increased in the ratio of 2n(n=0,1,2,3,4,5,6,7) in each sub-field. As such, since the sustain period varies in each sub-field, it is possible to implement the gray scale of the picture. While, the composition of the subfields can be set up variously. For example, the subfields can be composed by a selective erasing method in which a first subfield includes the reset period and other subfields do not include the reset period.

However, the conventional apparatus and method of realizing three dimensional image can not be applied to the PDP, because the one frame of the PDP is divided as a large number of subfields and derived. Therefore, an apparatus and a method of realizing three dimensional image for a PDP is necessary.

### SUMMARY OF THE INVENTION

Accordingly, an object of the present invention is to solve at least the problems and disadvantages of the background art.

An object of the present invention is to provide an apparatus and a method of realizing three dimensional image for a plasma display panel.

According to an embodiment of the present invention, an apparatus of realizing a three dimensional image for a plasma display panel, comprises: a goggle which an observer wears; a first subfield mapping part for receiving a left data, which includes an image displayed in a left side of said goggle, and assigning the left data on each left subfield; a second subfield mapping part for receiving a right data, which includes an image displayed in a right side of said goggle, and assigning the right data on each right subfield; a subfield composing part for arranging the left subfields and the right subfields transmitted by said first subfield mapping part and said second subfield mapping part in one frame; and a goggle signal generating part for generating a left goggle signal and a right goggle signal, and applying the left goggle signal and the right goggle signal to said goggle corresponding to the left subfields and the right subfields arranged by said subfield composing part.

According to other embodiment of the present invention, an apparatus of realizing a three dimensional image for a plasma display panel, comprises: a first subfield mapping part for receiving a left data, which includes an image displayed in a left side of said goggle, and assigning the left data on each left subfield; a second subfield mapping part for receiving a right data, which includes an image displayed in a right side of said goggle, and assigning the right data on each right subfield; and a subfield composing part for arranging the left subfields and the right subfields transmitted by said first subfield mapping part and said second subfield mapping part in one frame; wherein said subfield composing part generates a left goggle signal and a right goggle signal, and applies the left goggle signal and the right goggle signal to said goggle corresponding to the left subfields and the right subfields arranged by said subfield composing part.

According to an embodiment of the present invention, a method for realizing a three dimensional image for a plasma display panel, comprises steps of: a first step for receiving a left data and a right data; a second step for assigning the left data on each left subfield and the right data on each right subfield; a third step for arranging the left subfields and the right subfields in one frame; a fourth step for generating a left goggle signal and a right goggle signal corresponding to the left subfields and the right subfields arranged in the one frame; and a fifth step for displaying a three dimensional image on a goggle corresponding to the left goggle signal and the right goggle signal.

The apparatus and method of realizing three dimensional image in accordance with embodiments of the present invention can display three dimensional image on a plasma display panel.

### BRIEF DESCRIPTION OF THE DRAWINGS

The invention will be described in detail with reference to the following drawings in which like numerals refer to like elements.

FIG. 1 is a schematic diagram depicting an apparatus for realizing three dimensional image in accordance with the background art.

FIG. 2 is signal graph depicting left/right goggle signals generated in the goggle signal generating part of FIG. 1.

FIG. 3 is a drawing depicting one frame of a plasma display panel.

FIG. 4 is a schematic diagram depicting an apparatus for realizing three dimensional image in accordance with an embodiment of the present invention.

FIG. 5 is a drawing depicting process of the subfield mapping part shown in FIG. 4.

FIG. 6 is a drawing depicting process of the subfield composing part shown in FIG. 4.

FIG. 7 is a drawing depicting process of the subfield composing part shown in FIG. 4 in accordance with other embodiment of the present invention.

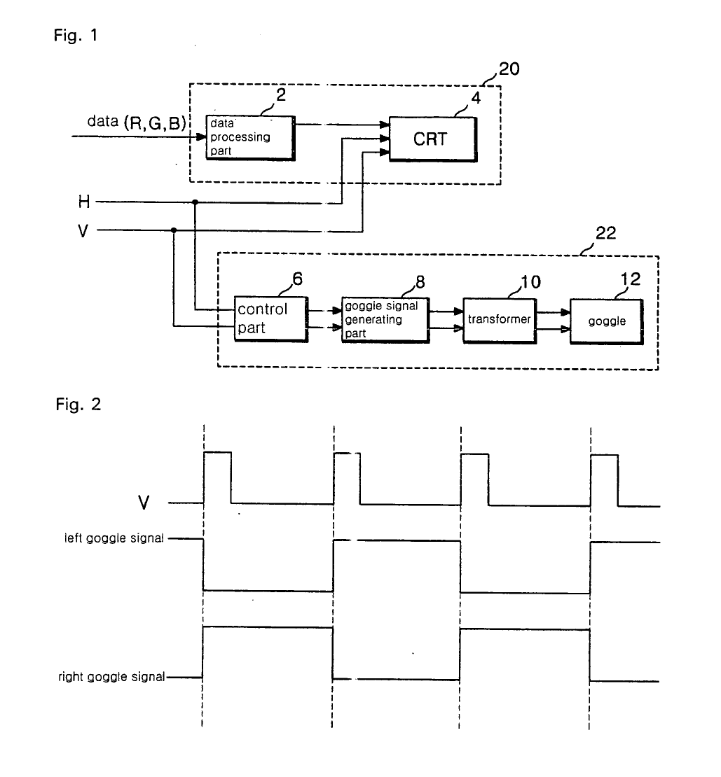

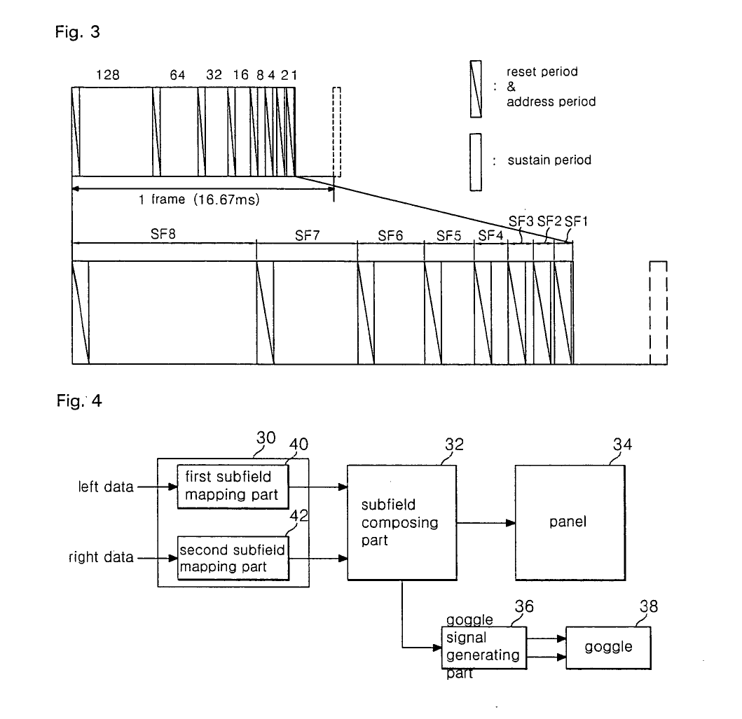

### DETAILED DESCRIPTION OF PREFERRED EMBODIMENTS

According to an embodiment of the present invention, an apparatus of realizing a three dimensional image for a plasma display panel, comprises: a goggle which an observer wears; a first subfield mapping part for receiving a left data, which includes an image displayed in a left side of said goggle, and assigning the left data on each left subfield; a second subfield mapping part for receiving a right data, which includes an image displayed in a right side of said goggle, and assigning the right data on each right subfield; a subfield composing part for arranging the left subfields and the right subfields transmitted by said first subfield mapping part and said second subfield mapping part in one frame; and a goggle signal generating part for generating a left goggle signal and a right goggle signal, and applying the left goggle signal and the right goggle signal to said goggle corresponding to the left subfields and the right subfields arranged by said subfield composing part.

Said subfield composing part arranges the left subfields on a first half part of the one frame, and the right subfields on a second half part of the one frame.

Said subfield composing part arranges the right subfields on a first half part of the one frame, and the left subfields on a second half part of the one frame.

Said subfield composing part arranges the left and the right subfields alternately on the one frame.

Said subfield composing part arranges a first subfield of the left subfields on a first subfield of the one frame.

Said subfield composing part arranges a first subfield of the right subfields on a first subfield of the one frame.

Said goggle signal generating part generates the left goggle signal when the subfield composing part arranges the left subfields, and applies an image of the left subfield to a left side of said goggle when the image of the left subfields is displayed on a plasma display panel; and generates the right goggle signal when the subfield composing part arranges the right subfields, and applies an image of the right subfield to a right side of said goggle when the image of the right subfields is displayed on a plasma display panel.

According to other embodiment of the present invention, an apparatus of realizing a three dimensional image for a plasma display panel, comprises: a first subfield mapping part for receiving a left data, which includes an image displayed in a left side of said goggle, and assigning the left data on each left subfield; a second subfield mapping part for receiving a right data, which includes an image displayed in a right side of said goggle, and assigning the right data on each right subfield; and a subfield composing part for arranging the left subfields and the right subfields transmitted by said first subfield mapping part and said second subfield mapping part in one frame; wherein said subfield composing part generates a left goggle signal and a right goggle signal, and applies the left goggle signal and the right goggle signal to said goggle corresponding to the left subfields and the right subfields arranged by said subfield composing part.

Said subfield composing part arranges the left subfield on a first half part of the one frame, and the right subfield on a second half part of the one frame.

Said subfield composing part arranges the right subfields on a first half part of the one frame, and the left subfields on a second half part of the one frame.

Said subfield composing part arranges the left and the right subfields alternately on the one frame.

Said subfield composing part arranges a first subfield of the left subfields on a first subfield of the one frame.

Said subfield composing part arranges a first subfield of the right subfields on a first subfield of the one frame.

Said subfield composing part generates the left goggle signal when the subfield composing part arranges the left subfields, and applies an image of the left subfield to a left side of said goggle when the image of the left subfields is displayed on a plasma display panel; and generates the right goggle signal when the subfield composing part arranges the right subfields, and applies an image of the right subfield to a right side of said goggle when the image of the right subfields is displayed on a plasma display panel.

According to an embodiment of the present invention, a method for realizing a three dimensional image for a plasma display panel, comprises steps of: a first step for receiving a left data and a right data; a second step for assigning the left data on each left subfield and the right data on each right subfield; a third step for arranging the left subfields and the right subfields in one frame; a fourth step for generating a left goggle signal and a right goggle signal corresponding to the left subfields and the right subfields arranged in the one frame; and a fifth step for displaying a three dimensional image on a goggle corresponding to the left goggle signal and the right goggle signal.

Said third step arranges the left subfields on a first half part of the one frame, and the right subfields on a second half part of the one frame.

Said third step arranges the right subfields on a first half part of the one frame, and the left subfields on a second half part of the one frame.

Said third step arranges the left and the right subfields alternately on the one frame.

Said fourth step generates the left goggle signal when the left subfields are arranged, and generates the right goggle signal when the right subfields are arranged.

Preferred embodiments of the present invention will be described in a more detailed manner with reference to the drawings.

FIG. 4 is a schematic diagram depicting an apparatus for realizing three dimensional image in accordance with an embodiment of the present invention.

As shown in FIG. 4, an apparatus for realizing three dimensional image in accordance with an embodiment of the present invention comprises a subfield mapping part 30, a subfield composing part 32, a panel 34, a goggle signal generating part 36, and a goggle 38.

The goggle 38 is shaped like glasses and an observer wears the goggle. The goggle 38 transmits the image displayed in the panel 34 selectively corresponding to the left/right goggle signal applied to the goggle 38 and makes the observer recognize two dimensional image displayed in the panel 34 as three dimensional image.

The subfield mapping part 30 received the left/right datum from the outside. And then, the subfield mapping part 30 assigns each left and right data on each subfield. In order to do this, the subfield mapping part 30 comprises a first subfield mapping part 40 and a second subfield mapping part 42.

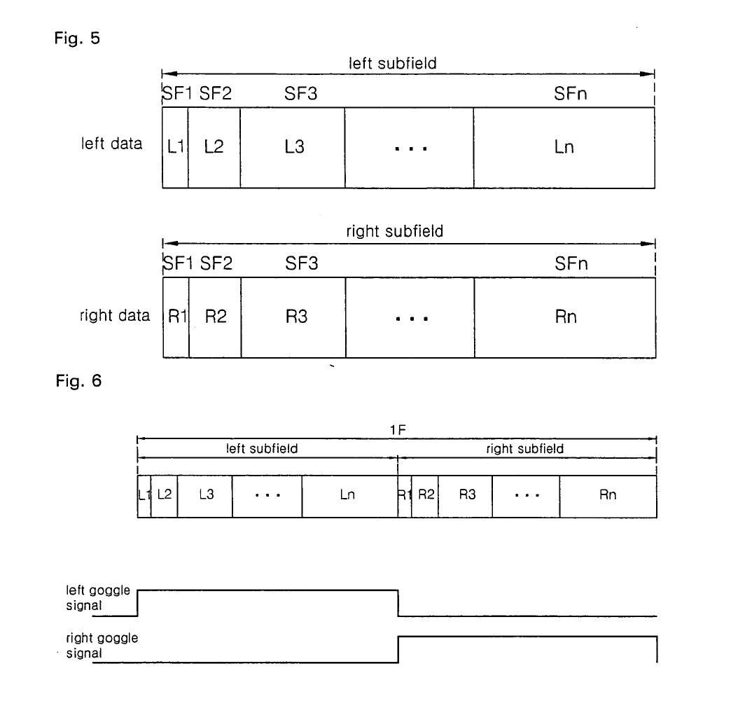

FIG. 5 is a drawing depicting process of the subfield mapping part shown in FIG. 4. As shown in FIG. 5, the first subfield mapping part 40 receives the left data and assigns the left data on each left subfield. The second subfield mapping part 42 receives the right data and assigns the right data on each right subfield. As like this, the left data is assigned on the left subfield and the right data is assigned on the right subfield, and then, corresponding to the left/right subfields, the goggle control signal can be generated. Here, the added period of the left/right subfield is set up to be within one frame.

While, various driving devices are installed in previous part of the subfield mapping part 30. For example, the various driving devices are a AD (analog-digital) converter for converting analog left/right datum to digital left/right datum and an inverted gamma revision part for doing inverted gamma revision. Here, the left data (left signal) and the right data (right signal) are signals transmitted from a broadcasting station and supplied to the goggle. The broadcasting station transmits the left signal and the right signal each photographed by the left camera and the right camera in order to represent the image as three dimensional image. Here, the left signal is the image supplied to the left of the goggle (the left of the glasses), and the right signal is the image supplied to the right of the goggle (the right of the glasses).

FIG. 6 is a drawing depicting process of the subfield composing part shown in FIG. 4. As shown in FIG. 6, the subfield composing part 32 assigns the left/right subfields from the subfield mapping part 30 on one frame. Here, the subfield composing part 32 arranges the left subfields on a first half part of the one frame, and the right subfields on a second half part of the one frame. While, the subfield composing part 32 also can arrange the right subfields on a first half part of the one frame, and the left subfields on a second half part of the one frame.

The goggle signal generating part 36 generates the left/right goggle signals corresponding to the left/right subfields arranged by the subfield composing part 32. Here, when the left subfield is arranged, the left goggle signal is generated, and when the right subfield is arranged, the right goggle signal is generated. Therefore, the goggle signal generating part 36 generates the left goggle signal during the first half part of one frame, on which the left subfields are assigned, and the right goggle signal during the second half part of one frame, on which the right subfields are assigned. While, according to other embodiment of the present invention, the subfield composing part 32 can generate the left/right signals. That is to say, the subfield composing part 32 arranges the left/right subfields on one frame and generates the left/right signals corresponding to the left/right subfields.

The panel 34 displays the image corresponding to the datum supplied from the subfield composing part 32. Practically, various driving parts are installed between the panel 34 and the subfield composing part 32. For example, various driving parts are a data driving part for supplying data and a scan driving part for supplying scan pulse.

The goggle 38 repeats transmitting and untransmitting operation corresponding to the left/right goggle signals supplied to the goggle 38. For example, when the left goggle signal is supplied to the goggle 38, the image of the panel 34 is supplied to the left of the goggle 38 (the left of the glasses). At this time, the image is not supplied to the right of the goggle 38 (the right of the glasses). And, when the right goggle signal is supplied to the goggle 38, the image of the panel 34 is supplied to the right of the goggle 38 (the right of the glasses). At this time, the image is not supplied to the left of the goggle 38 (the left of the glasses). As like this, the goggle 38 controls the location, to which the image is supplied, selectively corresponding to the left/right goggle signals, and accordingly, the observer can recognize the image displayed in the panel 34 as three dimensional image.

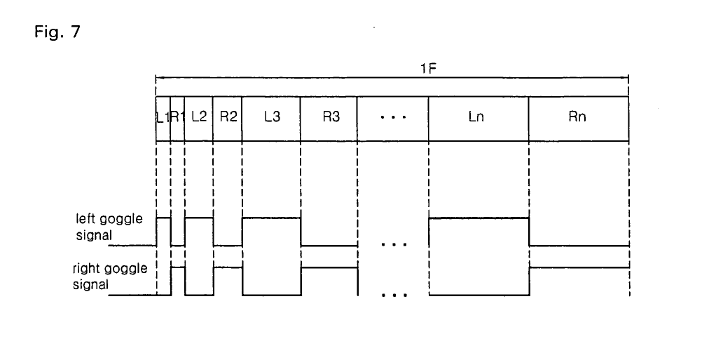

While, the operation of the subfield composing part 32 can be variously set up. FIG. 7 is a drawing depicting process of the subfield composing part shown in FIG. 4 in accordance with other embodiment of the present invention. As shown in FIG. 7, the subfield composing part 32 can arrange the left and the right subfields alternately on the one frame. That is, the subfield composing part 32 can arrange the first subfield of the left subfields L1 on the first subfield of one frame, and then arrange the first subfield of the right subfields R1. Therefore, the subfield composing part 32 arranges the subfields in the order of L1, R1, L2, R2, . . . , Ln, Rn (n is natural number). And, the subfield composing part 32 can arrange the subfields in the order of R1, L1, R2, L2, . . . , Rn, Ln (n is natural number).

Here, as shown in FIG. 7, the goggle signal generating part 36 generates the left/right goggle signals alternately in one frame corresponding to the arrange of the left/right subfields. The goggle signal generating part 36 generates the left goggle signal when the subfield composing part 32 arranges the left subfields, and generates the right goggle signal when the subfield composing part 32 arranges the right subfields. While, according to other embodiment of the present invention, the subfield composing part 32 can generate the left/right goggle signals by same method.

As described above, the apparatus and method of realizing three dimensional image in accordance with embodiments of the present invention can display three dimensional image on a plasma display panel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus of realizing a three dimensional image for a plasma display panel, comprising:
a goggle which an observer wears;
a first subfield mapping part for receiving a left data, which includes an image displayed in a left side of said goggle, and assigning the left data on each left subfield;
a second subfield mapping part for receiving a right data, which includes an image displayed in a right side of said goggle, and assigning the right data on each right subfield;
subfield composing part for arranging the left subfields and the right subfields transmitted by said first subfield mapping part and said second subfield mapping part in one frame; and
a goggle signal generating part for generating a left goggle signal and a right goggle signal, and applying the left goggle signal and the right goggle signal to said goggle corresponding to the left subfields and the right subfields arranged by said subfield composing part.

2. The apparatus of claim 1, wherein said subfield composing part arranges the left subfields on a first half part of the one frame, and the right subfields on a second half part of the one frame.

3. The apparatus of claim 1, wherein said subfield composing part arranges the right subfields on a first half part of the one frame, and the left subfields on a second half part of the one frame.

4. The apparatus of claim 1, wherein said subfield composing part arranges the left and the right subfields alternately on the one frame.

5. The apparatus of claim 4, wherein said subfield composing part arranges a first subfield of the left subfields on a first subfield of the one frame.

6. The apparatus of claim 4, wherein said subfield composing part arranges a first subfield of the right subfields on a first subfield of the one frame.

7. The apparatus of claim 1, wherein said goggle signal generating part generates the left goggle signal when the subfield composing part arranges the left subfields, and applies an image of the left subfield to a left side of said goggle when the image of the left subfields is displayed on a plasma display panel; and generates the right goggle signal when the subfield composing part arranges the right subfields, and applies an image of the right subfield to a right side of said goggle when the image of the right subfields is displayed on a plasma display panel.

8. An apparatus of realizing a three dimensional image for a plasma display panel, comprising:
a goggle which an observer wears;
a first subfield mapping part for receiving a left data, which includes an image displayed in a left side of said goggle, and assigning the left data on each left subfield;
a second subfield mapping part for receiving a right data, which includes an image displayed in a right side of said goggle, and assigning the right data on each right subfield; and
a subfield composing part for arranging the left subfields and the right subfields transmitted by said first subfield mapping part and said second subfield mapping part in one frame; wherein
said subfield composing part generates a left goggle signal and a right goggle signal, and applies the left goggle signal and the right goggle signal to said goggle corresponding to the left subfields and the right subfields arranged by said subfield composing part.

9. The apparatus of claim 8, wherein said subfield composing part arranges the left subfield on a first half part of the one frame, and the right subfield on a second half part of the one frame.

10. The apparatus of claim 8, wherein said subfield composing part arranges the right subfields on a first half part of the one frame, and the left subfields on a second half part of the one frame.

11. The apparatus of claim 8, wherein said subfield composing part arranges the left and the right subfields alternately on the one frame.

12. The apparatus of claim 11, wherein said subfield composing part arranges a first subfield of the left subfields on a first subfield of the one frame.

13. The apparatus of claim 11, wherein said subfield composing part arranges a first subfield of the right subfields on a first subfield of the one frame.

14. The apparatus of claim 8, wherein said subfield composing part generates the left goggle signal when the subfield composing part arranges the left subfields, and applies an image of the left subfield to a left side of said goggle when the image of the left subfields is displayed on a plasma display panel; and generates the right goggle signal when the subfield composing part arranges the right subfields, and applies an image of the right subfield to a right side of said goggle when the image of the right subfields is displayed on a plasma display panel.

15. A method for realizing a three dimensional image for a plasma display panel, comprising steps of:
a first step for receiving a left data and a right data;
a second step for assigning the left data on each left subfield and the right data on each right subfield;
a third step for arranging the left subfields and the right subfields in one frame;
a fourth step for generating a left goggle signal and a right goggle signal corresponding to the left subfields and the right subfields arranged in the one frame; and
a fifth step for displaying a three dimensional image on a goggle corresponding to the left goggle signal and the right goggle signal.

16. The method of claim 15, wherein said third step arranges the left subfields on a first half part of the one frame, and the right subfields on a second half part of the one frame.

17. The method of claim 15, wherein said third step arranges the right subfields on a first half part of the one frame, and the left subfields on a second half part of the one frame.

18. The method of claim 15, wherein said third step arranges the left and the right subfields alternately on the one frame.

19. The method of claim 15, wherein said fourth step generates the left goggle signal when the left subfields are arranged, and generates the right goggle signal when the right subfields are arranged.
